(19) United States
(12) Patent Application Publication
(10) Pub. No.: US 2005/0042414 A1
(43) Pub. Date: Feb. 24, 2005

(54) Methods of making sealing members for induction sealing of containers

(76) Inventors: Jeffrey J. Malay, Mound, MN (US); Ali El-Afandi, Maplewood, MN (US); Jay Gouliard, Minneapolis, MN (US); Julie Holmstrom, Savage, MN (US); David C. Wagner, Eden Prairie, MN (US); Wynn S. Wiksell, Plymouth, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/645,875

(22) Filed: Aug. 19, 2003

(51) Int. Cl. B32B 31/00; B32B 5/00

(52) U.S. Cl. 428/98; 83/13; 156/256; 234/2

(57) ABSTRACT

A method of making individual sealing members for containers including the steps of conveying a sheet of material in a travel direction relative to a die cutter to bring a portion of the sheet into alignment with the die cutter, then moving the die cutter into engagement with the sheet and cutting a plurality of sealing members from the sheet. The cutter comprises a plurality of cutting surfaces shaped and arranged for cutting a pattern of sealing members from the sheet, each of the sealing members comprising a base portion and first and second extending tabs. The pattern includes positioning the sealing members so that one of the extending tabs of a first sealing member extends into a space between the base portion of a second sealing member and the base portion of a third sealing member. The method then includes separating the sealing members from the sheet of material.

### TECHNICAL FIELD

The present invention relates to sealing of containers and more particularly relates to methods of manufacturing and applying dual-tab sealing members to containers using induction sealing methods.

### BACKGROUND OF THE INVENTION

Various types of consumer-sized packaging and containers are used in the food industry for holding and transporting liquid, solid, and semi-solid food products. The containers are typically designed to protect the contents of the container from mechanical and environmental hazards or contamination that can be encountered at any time after packaging and prior to the use of the product by the consumer. The packaging usually provides the consumer with relatively easy access to the contents of the container, sometimes with the added safety feature of tamper-resistant or tamper-evident seals that serve to both seal the contents of the container against external damage or contamination and also to provide the user with a visual means of quickly determining whether the product has previously been opened or used.

Some of the containers used in the food industry include bottles and jars, which are often rigid or semi-rigid and made from glass or plastic. Plastics are often preferable to glass since plastic materials are typically lightweight, can be precisely molded into a wide variety of shapes and sizes, can be produced at a relatively low cost, and are relatively easy to seal, such as with tamper-resistant or tamper-evident sealing members. In cases where a sealing member is used to cover the opening of such a container, the sealing member may either be used alone to seal the container, or may be used in combination with another protection device, such as a cap. When a sealing member is used alone on a container, the sealing member is often designed to be strong enough to resist damage during the various shipping and handling processes that can occur before a consumer opens the container for use or consumption of its contents. Using a sealing member in combination with a cap on the container also provides additional protection during shipping and handling of the product, and the cap can also provide the benefit of being removable and replaceable, as desired. For example, caps and containers can have mating threads that allow the cap to be removed for access to the contents of the container for use or consumption, after which the cap can be replaced by screwing it back onto the container, such as for later access to the remaining contents of the container. Caps that snap or are otherwise secured onto the top of a container can similarly be used for resealing purposes.

When sealing members are used to seal a container, the sealing member is typically a relatively thin membrane-type material that is sealed or adhered to the top rim of the container. If a cap is also used, the sealing member will be positioned between the rim of the container and the inside top of the cap. This cap also provides pressure to hold the sealing member against the rim of the container. The sealing members used are often foil laminates that consist of at least a foil layer, such as aluminum, and a layer of a heat activated polymer or adhesive that is selected to be compatible with the container material in order to provide good adherence between the materials. These sealing members are often secured to the rim of the container by a process commonly referred to as induction sealing or induction heating. In induction sealing processes, a foil laminate sealing member is typically placed on the rim of a container, and then an induction heater creates an electromagnetic field through which the container and sealing member are passed. This field induces an electromagnetic current into the foil layer that causes the foil to heat, which in turn melts the polymer or adhesive layer, which causes the adhesive layer to bond to the rim of the container.

While it is important to provide a sealing member that protects the contents of a container from intentional and unintentional tampering or contamination, it is also desirable for that same sealing member to be removable by the consumer for access to the contents of the container. In some cases, the sealing member may only be removable by using a sharp instrument, such as a knife, to puncture the seal, which then provides an access hole for further tearing or severing of the seal. However, in order to allow a consumer to remove at least a portion of a sealing member without the use of additional tools, sealing members are sometimes provided that have at least a portion extending beyond the rim of the container. For example, the perimeter of the sealing member may be slightly larger than the perimeter of the top of the container to provide a “free edge” of the sealing member for the consumer to grasp at some location around the perimeter of the container opening to pull the seal away from the container. Due to manufacturing inconsistencies (e.g., the difficulty of consistently centering a seal on the rim of a container) and other considerations, such as the tendency of any overhanging seal material to undesirably adhere to the sides of the container during an induction sealing process, it is often necessary for the consumer to spend considerable time trying to find a free edge of the sealing member that is large enough to grasp to pull such a seal from the container. In some cases, the entire overhanging portion of the sealing member may be adhered to the sides of the container, making it extremely difficult for the consumer to access any free edges of the seal and thereby again necessitating the use of a sharp instrument to open the container. Even if the consumer can find a free edge of the seal, however, it may not be large enough to grasp, particularly for a consumer having large fingers or having relatively low gripping strength. While it is possible to make the entire perimeter of the sealing member even larger to provide additional material for possible gripping, this additional material can exasperate the problem since the larger piece of material that extends or overhangs beyond the edge of the container is often even more likely to adhere to the sides of the container during the sealing process. This is particularly true when using induction sealing techniques to seal a container with a cap, since the close proximity of a cap to the container often tends to force any extending portion of the seal toward or against the sides of the container immediately adjacent to the rim of the container, which further encourages it to adhere to the container sides.

In an attempt to address this problem, another seal design commonly used for providing consumers with instrument-free access to the contents of a container is with the use of sealing members having tabs that extend beyond the perimeter of the container opening. These sealing members are often provided with at least one extending tab that can be grasped and pulled toward the center of the container opening to pull the sealing member away from the rim of the container. These sealing members may be prone to the same problems described above relative to seals that have a larger perimeter than the perimeter of the container opening, however, in that any extending tab or tabs can adhere to the sides of the container during the sealing process. In some cases, the consumer may be able to pry such a tab away from the side of the container, such as with a fingernail, but in other cases the consumer will again need an instrument to remove the seal. In addition, because it is possible that any extending tab or tabs can be damaged during the sealing process or by the threads of a cap screwed onto a container, for example, it is possible that there will be no undamaged or unadhered tab portion available to the consumer when attempting to remove the seal.

Making sealing members with tabs positioned around the perimeter of a sealing member creates a sealing member that is larger in area than a sealing member without tabs. Thus, sealing members with tabs necessarily require more raw materials for making such sealing members as compared to sealing members with no tabs. To minimize the amount of extra raw material that is needed to make these sealing members, it is known to position the sealing members on the sheet from which they will be cut so that the sealing members are as close to one another as possible without the tabs overlapping with adjacent sealing members. Thus, seals having smaller tabs will typically allow for a pattern including more seals across the length and/or width of the material than seals having larger tabs. However, because larger tabs can also provide better gripping for the consumer and easier seal removal, it is desirable to provide methods and devices for manufacturing and assembling relatively large tabs for container seals, while minimizing the amount of material used and waste material generated in the manufacturing of such seals.

### SUMMARY OF THE INVENTION

In one aspect of this invention, a method of making individual sealing members for containers from a sheet of material is provided, the method including the steps of conveying a sheet of material in a travel direction relative to a die cutter to bring a portion of the sheet into alignment with the die cutter, then moving the die cutter into engagement with the sheet and cutting a plurality of sealing members from the sheet. The cutter comprises a plurality of cutting surfaces shaped and arranged for cutting a pattern of sealing members from the sheet, each of the sealing members comprising a base portion and first and second extending tabs. The pattern includes positioning the sealing members so that one of the extending tabs of a first sealing member extends into a space between the base portion of a second sealing member and the base portion of a third sealing member. The method then includes separating the sealing members from the sheet of material. This separating step may include punching the sealing members from the sheet in a direction that is generally perpendicular to the travel direction of the sheet of material.

In accordance with the present invention, the pattern of sealing members may further include positioning the sealing members so that a first reference line extends diagonally relative to the travel direction of the sheet, wherein the first reference line intersects the base portion of the first sealing member and a longitudinal centerline of the first and second extending tabs of the first sealing member and further intersects the base portion of a fourth sealing member and a longitudinal centerline of the first and second extending tabs of the fourth sealing member. This first reference line may further be positioned tangentially to the base portion of the second and third sealing members and may be oriented at an angle of at least about 45 degrees relative to the travel direction of the sheet. The pattern may further include a second reference line that extends in a generally perpendicular direction to the first reference line, wherein the second reference line extends through a center point of the base portions of the second and third sealing members, thereby establishing a first diagonal row of sealing members comprising the second and third sealing members. The first extending tab of each of the sealing members may be oriented at approximately 180 degrees from the second extending tab of each of the sealing members.

In another aspect of the invention, a method is provided of maximizing a quantity of individual sealing members cut from a sheet of material having first and second opposite edges. The sealing members each comprise a base portion and two tab portions extending from the base portion and positioned on approximately opposite sides of the base portion, the method comprising the steps of providing a cutting mechanism for cutting individual sealing members in a pattern of rows. The rows are generally parallel to each other, wherein each row is diagonally oriented relative to the first and second edges of the sheet, and wherein at least one of the tab portions of each of the sealing members is positioned in a space between the base portions of two adjacent sealing members. The method then comprises the step of moving a sheet of material relative to the cutting mechanism to bring a portion of the sheet into alignment with the die cutter and engaging the cutting mechanism with the sheet and cutting a plurality of individual sealing members from the sheet.

In another aspect of the invention, a sheet of material is provided, the sheet including a pattern of cut sealing members to be removed from the sheet. Each sealing member has a base portion and first and second extending tabs, wherein the pattern includes an arrangement of sealing members including at least one of the extending tabs of each sealing member extending into a space between the base portion of two adjacent sealing members. The pattern may further include positioning the sealing members so that a first extending tab of a first sealing member extends into a space between the base portion of a second sealing member and the base portion of a third sealing member. The pattern may even further include positioning the sealing members so that a first reference line is positioned tangentially the base portions of second and third sealing members and so that the first reference line intersects the base portion of the first sealing member and a longitudinal centerline of the first and second extending tabs of the first sealing member and further intersects the base portion of a fourth sealing member and a longitudinal centerline of the first and second extending tabs of the fourth sealing member. In this aspect of the invention, the first extending tab of each of the sealing members may be oriented at approximately 180 degrees from the second extending tab of each of the sealing members.

### BRIEF DESCRIPTION OF THE DRAWINGS

The present invention will be further explained with reference to the appended Figures, wherein like structure is referred to by like numerals throughout the several views, and wherein:

FIG. 1 is a cross-sectional view of a container cap having a threaded interior chamber;

FIG. 2 is a cross-sectional view of a container assembly including the container cap of FIG. 1 assembled onto a neck portion of a container;

FIG. 3 is a top view of multiple sealing members arranged on a sheet of material in a pattern that minimizes material waste, in accordance with the present invention; and

FIG. 4 is a perspective view of a representative manufacturing operation in which multiple sealing members of the present invention are cut from a sheet of material.

### DETAILED DESCRIPTION OF THE PREFERRED EMBODIMENTS

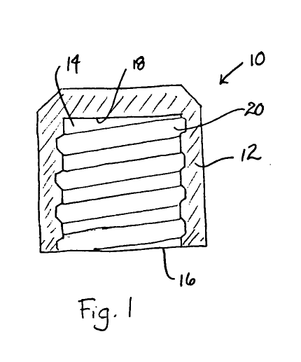

Referring now to the Figures, wherein the components are labeled with like numerals throughout the several Figures, and initially to FIG. 1, one preferred configuration of a screw cap 10 is shown, which generally includes an outer shell 12 surrounding an inner chamber 14. The inner chamber 14 includes an opening 16 at one end and a top wall or roof 18 at its opposite end, and is provided with inner screw threads 20 that preferably extend from the opening 16 to the top wall 18. The outer surface of the cap 10 may be provided with other structure or texture (not shown) to provide a better surface for gripping by a consumer, such as multiple ribs or knurls around the perimeter of the cap, although such structure or texture is not required.

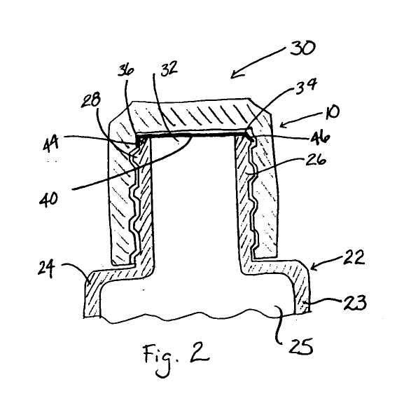

FIG. 2 further illustrates a portion of a container 22 including a body portion 23 having relatively vertical sidewalls, and a shoulder portion 24 that serves as the transition between the body 23 and an extending neck portion 26. Neck portion 26 is provided with outer screw threads 28 on its outer surface that are selected to cooperate with the inner screw threads 20 of the cap 10. In this way, the threads 20 of the cap 10 can be mated with the threads 28 of the container 22 to provide an assembly 30 in which the cap 10 is screwed onto the neck portion 26 of the container 22. Neck portion 26 further includes an opening or inner chamber 32 surrounded at one end by a peripheral rim 34, the rim having a relatively flat upper surface 36. Alternatively, the upper surface 36 may be angled to improve certain aspects of the sealing process. The opposite end of the chamber 30 opens to the body portion 23 of the container 22, which is the portion of the container 22 that holds the products, such as food products. The assembly 30 further includes a sealing member or seal 40 positioned between the upper surface 36 of the neck portion 26 and the top wall 18 of the cap 10, as will be described in further detail below.

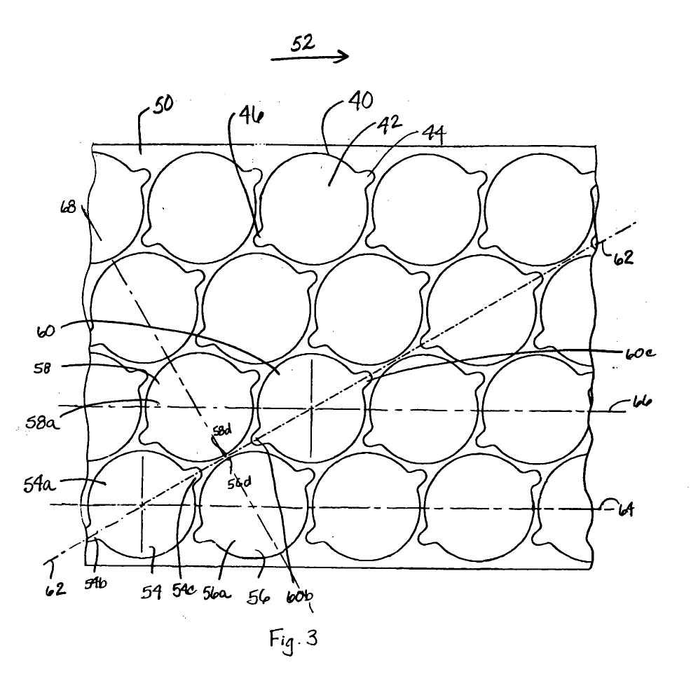

One preferred embodiment of a sealing member or seal 40 in accordance with the present invention is illustrated in FIG. 3, which shows a plurality of these sealing members 40 arranged in a pattern that minimizes material waste while maximizing the length of the extending tabs. Each sealing member 40 includes a base portion 42, a first tab 44, and a second tab 46, where the first tab 44 is preferably positioned at approximately 180 degrees from the second tab 46 relative to the periphery of the base portion 42. It is further preferable that the outer periphery of the base portion 42 is slightly larger in size than the outermost periphery of the top surface of the container onto which the sealing member will be secured. It is understood, however, that the outer periphery of the base portion 42 may be approximately equal to or slightly smaller than the outermost periphery of the top surface of the container, as long as the base portion 42 is not so small that it can fall through the innermost periphery of the top container surface or peripheral rim 34. In any case, the base portion 42 of each member 40 should at least be large enough that a sufficient portion of its surface can contact the peripheral rim of a container so that an adequate seal can be achieved. Alternatively, the cap may be omitted in such arrangements.

As described above, the base portion 42 is preferably generally circular in shape, with its outermost periphery being similar in shape to that of the peripheral rim 34. It is contemplated, however, that the base portion 42 could be elliptical or oval in shape, or may be irregularly shaped, wherein the shape selected should closely match that of the top surface of the container rim onto which it will be sealed. In addition, the inner chamber 32 of the container may have a different shape than the outer surface of the container. For example, the inner chamber 32 of the neck portion 26 may be generally cylindrical, while the outer surface of that neck portion 26 may be elliptical. In cases where the outer surface of the neck portion is not round or cylindrical, any cap used on such a container will not typically be threaded for screwing onto the container. Rather, a cap used on such a container will preferably snap or otherwise attach to the neck portion of the container.

Referring again to FIG. 2, the sealing member 40 of FIG. 3 includes the tabs 44 and 46 of FIG. 3, which are shown as extensions beyond the peripheral rim 34 of the container 22. In this figure, the tabs 44 and 46 are arranged to be approximately opposite each other, which can provide an advantage in the assembly process, depending on the arrangement of the tabs relative to the threads 20 of the cap 10 and the threads 28 of the container 22. In particular, when the threads 20 of the cap 10 terminate at or near the roof or top wall 18 of the inner chamber 14, and the threads 28 of the neck portion 26 similarly terminate at or near the peripheral rim 34 of the neck portion 26, as shown, the cap 10 can pinch an extending tab portion between the screw threads and/or between the threads and the top wall 18 of the inner chamber 14 when the cap 10 is screwed completely onto the neck portion 26. It is noted that this pinching of the tab by the threads will occur when an extending tab is sufficiently long that it extends down the side of the container neck and into the area where the threads are engaged with each other. While this pinching of a tab can damage or destroy a particular tab, the other tab of the sealing member 40, which is located approximately 180 degrees from the pinched tab, will likely be completely undamaged due to its position relative to this tab. In other words, since the other tab would be located on the opposite side of the neck portion 26 from a tab that was damaged by pinching between threads, this tab would consequently be located in an area where the threads 20 and 28 mate at a point considerably lower along the length of the neck portion 26. Therefore, this other tab would not be pinched between the threads of the cap and neck portion. In this way, although one tab may be damaged, it is likely that the tab on the opposite side will have a sufficiently long portion that is not pinched between threads or adhered to any surfaces so that the consumer may grasp this portion to remove the sealing member from the container.

The sealing members or seals of the present invention are preferably multi-layered film products that can generally seal containers through the use of high frequency activation or heating of a heat-seal coating, which may be used in combination with the application of pressure to the sealing member. In general, the sealing members are preferably membranes made from aluminum foil laminates or thermoplastic films that are typically tamper-evident or tamper-resistant and, depending on the material selected, may additionally provide a barrier to moisture and gases that can contaminate the contents of the container. Further, it is preferred that the sealing members are made from materials that are sufficiently rigid to be cut into the desired shapes and materials that possess the necessary heat transfer characteristics to activate the desired layers for proper securing of the sealing member to the cap. In particular, the sealing members preferably comprise multiple layers, which layers can further preferably include any of a wide variety of materials that are known to be used for induction heating or induction sealing. The materials from which the sealing members are made preferably include at least a foil layer, such as aluminum, and a heat-activated adhesive layer, which may be a polymeric adhesive layer, for example. The adhesive layer should be selected to be compatible with the container material in order to promote a good seal between the two materials. Additional layers may be included, as desired and known in the art, such as foam layers, wax layers, paper layers, polymeric layers, or other layers, each of which can provide different sealing features that may be desirable and/or necessary depending on the container onto which the sealing member will be secured, the materials that will be held within that container, and other factors.

FIG. 3 illustrates multiple sealing members having relatively long extending tabs arranged in a pattern that maximizes the number of sealing members that can be positioned along a particular length and width of a sheet or continuous roll of material, in accordance with the present invention. In particular, FIG. 3 illustrates a portion of a sheet of material 50, which, as shown, is a continuous roll of material that is moving in a travel direction 52. The material may instead be provided in individual material sheets from which sealing members can be cut or removed; however, this method may be less efficient than the relatively continuous production method allowed by providing the material in a roll form. In either case, the sealing members 40 of the present invention having a body portion 42 and two tabs 44, 46 are preferably advantageously arranged generally in the pattern shown in order to maximize the length of the tabs while minimizing the amount of waste generated in the conversion process. To better describe this arrangement, four adjacent sealing members 54, 56, 58, and 60 are described in further detail below, where each sealing member has a body portion designated with a suffix ‘a’, a first tab designated with a suffix ‘b’, and a second tab designated with a suffix ‘c’ (e.g., sealing member 54 includes a body portion 54a, a first tab 54b, and a second tab 54c).

As shown, sealing members 54, 56, 58, and 60 are arranged as close as possible to each other without any portion of adjacent sealing members overlapping each other. In particular, the arrangement including two tabs opposite each other on each sealing member allows for a pattern in which a reference line 62 intersects the center of sealing members 54 and 60, and extends generally longitudinally through center of the tabs 54b, 54c, 60b, and 60c of these sealing members 54 and 60, respectively. At the same time, this reference line 62, which also extends between the sealing members 56 and 58, is positioned to be generally tangential to the both of the body portions 56a and 58a of the sealing members 56 and 58. Further, a reference line 64 is shown which extends generally in the material movement direction 52 and also extends through the center of sealing members 54 and 56. Similarly, a reference line 66 extends generally parallel to the reference line 64 and also extends through the center of sealing members 58 and 60. This particular geometry provides a series of rows of sealing members positioned in a diagonal row that corresponds with a reference line 68, the rows being generally perpendicular to the reference line 62 and thereby diagonally positioned relative to the material movement direction 52. Further, each of the diagonal rows of sealing members is parallel to each adjacent diagonal row of sealing members along the length of the sheet 50.

The seals are thus advantageously arranged so that at least one tab of each sealing member is positioned in the arcuate areas between the body or base portions of two adjacent sealing members to maximize the length of the tabs for each sealing member. In one particular example used to better illustrate this arrangement or pattern, the sealing members 56 and 58 are closest to each other where their curvatures make them closest to the reference line 62 (designated as points 56d and 58d in the figure). These curves of the body portions 56a and 58a diverge from each other when moving from the points 56d and 58d toward the sealing member 54, providing an open, substantially triangular area between the two sealing members 56 and 58. Advantageously, the tab 54c of sealing member 54 is positioned to extend into this substantially triangular area, thereby allowing for close spacing of the sealing members relative to each other without overlap of any of the tabs or body portions of the sealing members. In an arrangement such as that described, the sealing members can be closer to each other across the length of the material, the width of the material, or both the length and width of the material, in order to minimize the amount of waste material between adjacent sealing members that is generated by the conversion process. Another advantage provided by the close spacing of sealing members is that more sealing members can be produced at the same line or material speed than if the sealing members were spaced further apart. That is, if the center spacing between the sealing members were larger, the line speed would necessarily need to be increased to have the same output of cut sealing members for a certain time period, where such increases in speed can sometimes be difficult or impossible due to equipment limitations.

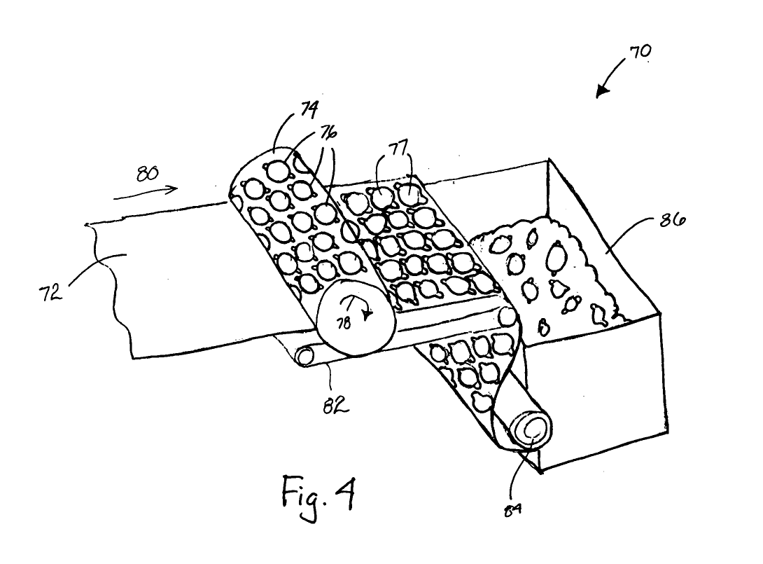

FIG. 4 illustrates a portion of one preferred embodiment of a production or conversion system 70 in accordance with the present invention for converting a continuous sheet of sealing material 72 into a plurality of sealing members 77 while minimizing the waste material that is generated. The sheet of sealing material 72 may be provided to the system 70 immediately after another processing step, such as a lamination process, or may be manufactured and processed in a different location and provided as a completed product to the system 70, such as in a roll form. In either case, a rolling die cutter 74 is shown in this system 70 with die blades or edges 76 mounted on the outer periphery of a circular drum in a pattern that matches that of the sealing members 77 that are to be cut from the sheet 72. As the drum rotates in a direction 78, the die blades are pressed downward into the sheet of sealing material 72 that is moving in a direction 80 at a relatively constant speed past the die cutter 74. The speed at which the die cutter 74 rotates is preferably synchronized with the speed at which the sheet of sealing material 72 moves so that the cut sealing members 77 have relatively clean edges and are of a desired size and shape that matches that of the die blades 76.

The sheet of sealing material 72 continues to move in the direction 80 after being cut, such as can be facilitated by contact with a rotating belt or conveyor 82, or any other device or system that moves the sheet of material in the direction 80. After the blades 76 of the die cutter 74 cut the sheet of material 72, the individual sealing members 77 can be separated from the sheet 72 in a variety of ways, one of which is illustrated relative to the embodiment of FIG. 4. In particular, the sheet 72 continues to move past the die cutter 74 in the direction 80 until the portion of the sheet 72 from which the sealing members 77 were cut reaches the end of the conveyor 82. At this point, the sheet 72 is directed downward toward a scrap roll 84 that winds up the scrap material having holes that correspond with the removed sealing members 77. Because there will no longer be any forces keeping the severed sealing members in contact with the sheet 72, the sealing members 77 will tend to fall from the sheet 72 into a collection bin 86 at the general area where the sheet 72 begins to move in a direction that is different from the direction 80. Once the bin 86 contains a certain number of sealing members 77, or the converting process is terminated for some other reason, the bin 86 can be removed from the system 70 to another location where the sealing members 77 can be secured onto the openings of containers using a variety of processing arrangements.

Alternatively, sealing members may be cut from a continuous sheet of sealing material using an indexing process with a different type of die cutter. In another example of a conversion system that can be used in accordance with the present invention, a sheet of sealing material is provided to a processing or converting system and is moved or indexed forward along a travel path by incremental amounts with a brief pause between subsequent indexing movements. This pause period provides the necessary time for a reciprocating die cutter to move in a generally perpendicular direction to the sealing material sheet to cut the pattern or periphery of the sealing members through the sealing material sheet. The die cutter may further include a series of punches, each of which moves through the interior periphery of the shaped die blades to push the severed sealing member downward and away from the material sheet. In this system, a series of caps that are indexing at the same rate as the sheet of material can be positioned directly below the sealing members so that each punch can push a sealing member into a corresponding cap. The cutting and punching operations preferably occur generally simultaneously in order to maximize the speed of the conversion system. The die cutter then moves away from the sealing material sheet and back to its starting position while the sheet is again indexed forward until the next portion of the sealing material is properly positioned relative to the die cutter for cutting the next section of the sealing material. The caps with inserted sealing members may also then be conveyed to either a capping operation, a collection bin, or some other location. This cycle will be repeated as many times as necessary to produce the desired quantity of sealing members. The other processing steps described above relative to the rolling die cutter may similarly be used in this conversion process, such as winding of the scrap roll and collection of the individual sealing members into a collection bin if they are not already inserted into caps.

While the conversion systems described above are shown and described as comprising certain processing equipment, the equipment used for processing and converting sealing members may include more, less, or different pieces of equipment for converting sheets of sealing material into individual sealing members. For instance, the individual sealing members may be moved from the sheet of waste by another conveyor or otherwise removed from the sheet in a more orderly manner than depositing the sealing members into a bin. In any system that is used for converting such sealing members, the previously described pattern of sealing members relative to a material sheet can advantageously maximize the number of individual sealing members that can be cut from a particular length and/or width of material.

Again referring to FIG. 3, it is further contemplated that each tab of the sealing members 40 may have a radius at its outer or distal end, however, it is understood that the tab may instead have a blunt, flat, or other shaped end. Such tab configurations can depend on a variety of manufacturing capabilities, such as the ability of a particular die cutter to cut certain shapes and angles. It is further understood that the choice of a flat end or a curved end for the tabs may also determine how closely the sealing members can be arranged relative to one another. For example, because a tab having a curved end essentially tapers from a wide portion at its proximal end (i.e., the end closest to the body portion) to a narrow portion at its distal end (i.e., the end furthest from the body portion), the distal end of this tab would typically require less space between adjacent sealing members in a particular pattern than if the distal end were the same width has the proximal end of the tab. In other words, a curved tab portion that decreases in width at distances further from the body portion may be able to be positioned closer to adjacent, curved surfaces without interfering with such surfaces. This can help to decrease the waste generated from a particular sheet or roll of sealing material.

As discussed above, some packaging methods include a container that is sealed with only a sealing member (i.e., without the additional use of a cap or other protective member). The sealing members 40 of the present invention can also be used for such containers, although the methods used for securing the sealing members to the containers may be different than the methods used for securing sealing members to containers having a cap. Further, although the above description refers mainly to caps that are screwed onto a neck portion of a container, a cap that is instead snap-fit or otherwise attached to the top of the container may be used, such as a cap element with external clips or other attachment devices. These caps or closures may be removable and replaceable, such as to reseal a container, or may not be replaceable after removal from the container. Further, the containers of the present invention may include a variety of shapes and sizes, including those having relatively wide or narrow openings, containers that have a constant diameter from top to bottom, or those containers that taper or have an irregular shape from the top to the bottom. In any case, the sealing members provided by the present invention can be used with any of these types of containers, caps, or combinations of caps and sealing members.

The containers onto which sealing members of the present invention may be secured include glass, plastic, and other flexible or non-flexible materials that can be formed into desired container shapes and onto which sealing members can be adhered. Materials from which the containers can be made can include, for example, high impact polystyrene (HIPS) and acrylonitrile butadiene styrene (ABS), which can be thermoformed to a desired shape, such as trays, tubs, and cups, which can be used to contain such food products as yogurt, margarine, and ice cream, for example. The containers may also be made of materials such as polyvinyl chloride (PVC) or polyethylene terephthalate (PET) that are often formed by extrusion molding or injection molding. These containers typically have good oil resistance and low gas permeability and are therefore can be used for tubs or bottles for edible oils, fruit juices, or fruit concentrates. High-density polyethylene is also commonly used for food bottles and jars, such as for milk, syrups, and vinegar, and polypropylene coextrusion materials are often used for containing foods such as mustard, jams, ketchup, and other products that have a relatively long shelf life. With any of these materials, the containers may be formed into a variety of different shapes and typically have a single opening that is positioned at or near the top of the container. It is noted that while the methods, devices, and sealing members of the present invention are most particularly described relative to the food industry, it is understood that the sealing members and the methods of producing such sealing members that are described herein are also applicable to other types of containers that hold products, such as cosmetics, automotive fluids, industrial products, and the like.

The present invention is particularly directed to sealing of containers using sealing members that are induction heated or sealed onto the peripheral rim of a container. However, it is contemplated that other methods of sealing may be used, where advantages similar to those of the present invention can be achieved. For example, the containers may be sealed with conductive or contact sealing processes or heating processes. When induction sealing or heating methods are used, the sealing members, which may be inserted into a cap, are preferably oriented by a piece of positioning equipment so that the layers of the sealing members are facing in the proper orientation relative to the container on which they will be placed or relative to the cap into which they will be inserted. Alternatively, the process of cutting sealing members from a sheet of sealing material can be accomplished with a piece of equipment immediately preceding the placement of such sealing members onto a container or into a cap (i.e., the sealing members can be cut “in-line” with the induction sealing equipment), where this cutting process also provides the sealing members in a certain orientation. In any case, the sealing members are then either inserted into a cap that is then placed on top of a container so that the sealing member is in contact with the peripheral rim of the container, or the sealing member is placed directly onto the peripheral rim of a container, where the container has previously been filled with a desired quantity of product. Although the construction of the sealing member may vary, as described above, the sealing member should be positioned so that the heat-activated sealant layer that will adhere to the container is the layer that is in contact with the peripheral rim of the container, while the foil or heat transfer layer is spaced further from the peripheral rim of the container.

The containers are then moved under an induction sealer, such as on a conveyor, so that they pass through an electromagnetic field created by the induction sealer. This field induces an electromagnetic current into the foil layer, resulting in a resistance-type heating of the foil layer. The relatively hot foil melts the polymer or adhesive coating of the sealing member, causing it to bond to the peripheral rim of the container, thereby providing the desired sealing of the container. If a cap is not used, an additional device or equipment may be necessary to provide pressure to the sealing member for proper sealing of the sealing member onto the container.

Referring again to FIG. 3, one specific preferred pattern for cutting sealing members from a sheet of material is described in further detail, as is described above relative to the present invention, along with a comparison of this pattern to that of a sealing member having a different configuration. The sealing members of the present invention may be provided for any size container openings, where the sealing members preferably include a body portion that closely matches the perimeter of the container opening on which it will be used and include tabs that are each as large as possible while facilitating a manufacturing operation with minimal waste. In this specific preferred embodiment, a plurality of generally identical sealing members are designed to be cut from a sheet of material, such as sealing member 54 and a series of sealing members that are generally identical to this sealing member. The sealing member 54 includes a body portion 54a having a diameter of approximately 1.495 inches (3.797 cm) and two tabs 54b and 54c that are approximately 0.20 inches (0.51 cm) long and are arranged at approximately 180 degrees from each other. Thus, the overall length of the sealing member 54, including tabs, is approximately 1.895 inches (4.699 cm) at its widest point, and 1.495 inches (3.797 cm) across at any point that does not include tabs. Further, the transitions between the tabs and the body portions of the sealing members are gradual rather than sharp, in order to minimize stress points between the portions of the sealing member. Such a configuration can help to minimize the chances that a tab will be torn when being pulled to remove the sealing member from the top of the container. In the specific embodiment being described here, a radius of 0.060 inches (0.152 cm) is provided as a transition between the body 54a of the sealing member 54 and each of the tab portions 54b and 54c, with the base portion of each tab being approximately 0.224 inches (0.569 cm) wide (as measured from the center point of the transition radius on either side of each tab. The distance between the center points of the sealing members 54 and 60 is approximately 2.697 inches (6.85 cm). The sealing members in this example are arranged generally as illustrated in FIG. 3, where this pattern of sealing members is cut from a sheet approximately 5.75 inches (14.61 cm) wide. This converting process results in approximately 13 percent of the sheet remaining as scrap or waste material for any given length of sheet material.

For comparison purposes, the amount of scrap or waste material generated for a sealing member having three tabs that were also 0.20 inches (0.51 cm) long and extending from a body portion also having a diameter of approximately 1.495 inches (3.797 cm) was calculated. These sealing members were arranged as close as possible to one another; however, because the sealing members having three tabs cannot be arranged in the same pattern as sealing members having two tabs, the body portions of the sealing members had to be moved farther from each other to accommodate the length of the tabs. This arrangement would result in approximately 25 percent of the sheet remaining as scrap or waste material.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of making individual sealing members for containers from a sheet of material, the method comprising the steps of:
conveying a sheet of material in a travel direction relative to a die cutter to bring a portion of the sheet into alignment with the die cutter;
moving the die cutter into engagement with the sheet and cutting a plurality of sealing members from the sheet, the cutter comprising a plurality of cutting surfaces shaped and arranged for cutting a pattern of sealing members from the sheet, wherein each of the sealing members comprises a base portion and first and second extending tabs, and wherein the pattern includes positioning the sealing members so that one of the extending tabs of a first sealing member extends into a space between the base portion of a second sealing member and the base portion of a third sealing member; and
separating the sealing members from the sheet of material.

2. The method of claim 1, wherein the pattern of sealing members further includes positioning the sealing members so that a first reference line extends diagonally relative to the travel direction of the sheet, wherein the first reference line intersects the base portion of the first sealing member and a longitudinal centerline of the first and second extending tabs of the first sealing member and further intersects the base portion of a fourth sealing member and a longitudinal centerline of the first and second extending tabs of the fourth sealing member.

3. The method of claim 2, wherein the first reference line is further positioned tangentially to the base portion of the second and third sealing members.

4. The method of claim 2, further comprising a second reference line that extends in a generally perpendicular direction to the first reference line, wherein the second reference line extends through a center point of the base portions of the second and third sealing members, thereby establishing a first diagonal row of sealing members comprising the second and third sealing members.

5. The method of claim 4, further comprising a second diagonal row of sealing members that is parallel to the first diagonal row of sealing members, wherein the first diagonal row is parallel to the second diagonal row, and wherein the second diagonal row comprises the first sealing member.

6. The method of claim 1, wherein the first extending tab of each of the sealing members is oriented approximately 180 degrees from the second extending tab of the same sealing member.

7. The method of claim 1, wherein the base portion of each of the sealing members is circular.

8. The method of claim 1, wherein a perimeter of the base portion of each of the sealing members corresponds with a perimeter of a container opening onto which the sealing member will be placed.

9. The method of claim 1, further comprising the step of providing the plurality of sealing members to a container sealing operation.

10. The method of claim 1, wherein the sheet of material is a continuous sheet of sealing material.

11. The method of claim 1, wherein the sheet of material is a first discrete sheet of sealing material, and wherein the method further comprises the step of conveying a second sheet of material in the travel direction to bring a portion of the second sheet into engagement with the cutter.

12. The method of claim 2, wherein the first reference line is oriented at an angle of at least about 45 degrees relative to the travel direction of the sheet.

13. The method of claim 1, wherein the pattern is repeated along the length of the sheet in the travel direction to provide a plurality of identical sealing members while maximizing the area of the sheet that comprises sealing members.

14. The method of claim 1, wherein the travel direction of the sheet of material is generally perpendicular to the direction of movement of the die cutter when the cutter is cutting the plurality of sealing members from the sheet of material.

15. The method of claim 1, wherein at least one extending tab of each sealing member is positioned to be adjacent to a base portion of at least one adjacent sealing member.

16. The method of claim 1, wherein the space between the base portions of the second and third sealing members is at least partially bounded by arcuate portions of the second and third sealing members.

17. The method of claim 1, wherein the die cutter is a rolling die cutter comprising a plurality of die blades arranged around the perimeter of the roller.

18. The method of claim 1, wherein the sheet of material comprises a heat-transfer layer and a heat-activated layer.

19. The method of claim 18, wherein the heat-transfer layer is a foil layer and the heat-activated layer is an adhesive layer.

20. The method of claim 1, wherein the step of separating the plurality of sealing members from the sheet of material comprises punching the sealing members from the sheet in a direction that is generally perpendicular to the travel direction of the sheet of material.

21. The method of claim 1, in combination with the steps of providing the sealing members to an induction sealing system for securing each of the sealing members to a container opening by induction sealing.

22. A method of maximizing a quantity of individual sealing members cut from a sheet of material having first and second opposite edges, wherein the sealing members each comprise a base portion and two tab portions extending from the base portion and positioned on approximately opposite sides of the base portion, the method comprising the steps of:
providing a cutting mechanism for cutting individual sealing members in a pattern of rows that are generally parallel to each other, wherein each row is diagonally oriented relative to the first and second edges of the sheet, and wherein at least one of the tab portions of each of the sealing members is positioned in a space between the base portions of two adjacent sealing members;
moving a sheet of material relative to the cutting mechanism to bring a portion of the sheet into alignment with the die cutter; and
engaging the cutting mechanism with the sheet and cutting a plurality of individual sealing members from the sheet.

23. A method of making individual sealing members for containers from a sheet of material, the method comprising the steps of:
conveying a sheet of material in a travel direction relative to a die cutter to bring a portion of the sheet into alignment with the die cutter; and
moving the die cutter into engagement with the sheet and cutting a plurality of sealing members from the sheet, the cutter comprising a plurality of cutting surfaces shaped and arranged for cutting a pattern of sealing members from the sheet, wherein each of the sealing members comprises a base portion and first and second extending tabs, and wherein the pattern includes positioning the sealing members so that at least one of the extending tabs of each sealing member extends into a space between the base portion of two adjacent sealing members.

24. A sheet of material comprising a pattern of cut sealing members to be removed from the sheet, each sealing member having a base portion and first and second extending tabs, wherein the pattern includes an arrangement of sealing members including at least one of the extending tabs of each sealing member extending into a space between the base portion of two adjacent sealing members.

25. The sheet of claim 24, wherein the pattern further includes positioning the sealing members so that a first extending tab of a first sealing member extends into a space between the base portion of a second sealing member and the base portion of a third sealing member.

26. The sheet of claim 25, wherein the pattern further includes positioning the sealing members so that a first reference line is positioned tangentially the base portions of second and third sealing members and so that the first reference line intersects the base portion of the first sealing member and a longitudinal centerline of the first and second extending tabs of the first sealing member and further intersects the base portion of a fourth sealing member and a longitudinal centerline of the first and second extending tabs of the fourth sealing member.

27. The sheet of claim 24, wherein the first extending tab of each of the sealing members is oriented approximately 180 degrees from the second extending tab of each of the sealing members.
